(19) United States
(12) Patent Application Publication
(10) Pub. No.: US 2025/0371798 A1
(43) Pub. Date: Dec. 4, 2025

(54) IMAGE RENDERING METHOD AND RELATED APPARATUS

(71) Applicant: TENCENT TECHNOLOGY (SHENZHEN) COMPANY LIMITED, Shenzhen (CN)

(72) Inventor: Xianfei SHEN, Shenzhen (CN)

(21) Appl. No.: 19/296,663

(22) Filed: Aug. 11, 2025

Related U.S. Application Data
(63) Continuation of application No. PCT/CN2024/098465, filed on Jun. 11, 2024.

(30) Foreign Application Priority Data
Jul. 3, 2023 (CN) 202310804142.2

(51) Int. Cl. G06T 15/50; G06T 15/20

(52) U.S. Cl. CPC G06T 15/506; G06T 15/20

(57) ABSTRACT

An image rendering method includes determining, according to a camera location of a virtual camera and an object location corresponding to a target object in a three-dimensional scene, whether a pixel in an imaging plane of the virtual camera overlaps with the target object, if so, determining, according to the pixel and the object location, a positioning point corresponding to a visible point, determining a distance between the visible point and the positioning point as a scattering distance, in the target object, corresponding to the pixel under a target rendering light source, and determining pixel information of the pixel based on the scattering distance and the target rendering light source. The visible point is on the target object and overlaps with the pixel. The positioning point is on the target object and is farthest away from the pixel on a straight line connecting the pixel and the visible point.

### CROSS-REFERENCE TO RELATED APPLICATIONS

This application is a continuation of Internation Application No. PCT/CN2024/098465, filed on Jun. 11, 2024, which claims priority to Chinese Patent Application No. 202310804142.2, filed with the China National Intellectual Property Administration on Jul. 3, 2023 and entitled “IMAGE RENDERING METHOD AND RELATED APPARATUS”, the entire contents of both of which are incorporated by reference.

### FIELD OF THE TECHNOLOGY

This application relates to the field of image processing technologies, and in particular, to an image rendering technology.

### BACKGROUND OF THE DISCLOSURE

Image rendering quality is one of key factors determining program use experience of a user. Rendering of a lighting effect is a difficult problem in image rendering, and how to simulate a realistic lighting effect is an important research problem in the image processing field.

In a related technology, when a lighting effect is rendered for a translucent object, light scattering of a light source in the translucent object needs to be simulated. For example, when a pixel value corresponding to a pixel in an image is determined, a light scattering distance corresponding to the pixel for each light source in a scene needs to be calculated, then a scattering effect of each light source on the pixel is calculated based on the light scattering distance corresponding to each light source, and finally, the pixel value of the pixel is obtained by combining a plurality of scattering effects.

It can be seen that, in the image rendering method for the translucent object in the related technology, a computational load is large, a large quantity of processing resources need to be consumed, and a load required for image rendering is high, resulting in low rendering efficiency.

### SUMMARY

In accordance with the disclosure, there is provided an image rendering method performed by a computer device and including determining, according to a camera location of a virtual camera and an object location corresponding to a target object in a three-dimensional scene, whether a pixel in an imaging plane of the virtual camera overlaps with the target object, and in response to determining that the pixel overlaps with the target object, determining, according to the pixel and the object location, a positioning point corresponding to a visible point. The visible point is a point, on the target object, that overlaps with the pixel, and the positioning point is a point, on the target object, that is farthest away from the pixel on a straight line connecting the pixel and the visible point. The method further includes determining a distance between the visible point and the positioning point as a scattering distance, in the target object, corresponding to the pixel under a target rendering light source, and determining pixel information of the pixel based on the scattering distance and the target rendering light source.

Also in accordance with the disclosure, there is provided a computer device including a memory storing a computer program, and a processor configured to execute instructions in the computer program to determine, according to a camera location of a virtual camera and an object location corresponding to a target object in a three-dimensional scene, whether a pixel in an imaging plane of the virtual camera overlaps with the target object, and in response to determining that the pixel overlaps with the target object, determine, according to the pixel and the object location, a positioning point corresponding to a visible point. The visible point is a point, on the target object, that overlaps with the pixel, and the positioning point is a point, on the target object, that is farthest away from the pixel on a straight line connecting the pixel and the visible point. The processor is further configured to execute instructions in the computer program to determine a distance between the visible point and the positioning point as a scattering distance, in the target object, corresponding to the pixel under a target rendering light source, and determine pixel information of the pixel based on the scattering distance and the target rendering light source.

Also in accordance with the disclosure, there is provided a non-transitory computer-readable storage medium storing a computer program that, when executed by a processor, causes a computer device including the processor to determine, according to a camera location of a virtual camera and an object location corresponding to a target object in a three-dimensional scene, whether a pixel in an imaging plane of the virtual camera overlaps with the target object, and in response to determining that the pixel overlaps with the target object, determine, according to the pixel and the object location, a positioning point corresponding to a visible point. The visible point is a point, on the target object, that overlaps with the pixel, and the positioning point is a point, on the target object, that is farthest away from the pixel on a straight line connecting the pixel and the visible point. The computer program, when executed by the processor, further causes the computer device to determine a distance between the visible point and the positioning point as a scattering distance, in the target object, corresponding to the pixel under a target rendering light source, and determine pixel information of the pixel based on the scattering distance and the target rendering light source.

### BRIEF DESCRIPTION OF THE DRAWINGS

FIG. 1 is a schematic diagram showing an image rendering method.

FIG. 2 is a schematic diagram showing an image rendering method in an actual application scene according to an embodiment of this application.

FIG. 3 is a flowchart of an image rendering method according to an embodiment of this application.

FIG. 4 is a schematic diagram showing an image rendering method according to an embodiment of this application.

FIG. 5 is a schematic diagram showing an image rendering method according to an embodiment of this application.

FIG. 6 is a schematic diagram showing an image rendering method according to an embodiment of this application.

FIG. 7 is a schematic diagram showing an image rendering method according to an embodiment of this application.

FIG. 8 is a flowchart of an image rendering method in an actual application scene according to an embodiment of this application.

FIG. 9 is a structural block diagram of an image rendering apparatus according to an embodiment of this application.

FIG. 10 is a structural diagram of a terminal according to an embodiment of this application.

FIG. 11 is a structural diagram of a server according to an embodiment of this application.

### DESCRIPTION OF EMBODIMENTS

The following describes embodiments of this application with reference to accompanying drawings.

Scattering is a common phenomenon when light travels through a translucent object. The light generally penetrates through a surface of the translucent object, is scattered due to interaction with a material, is reflected inside the object for a plurality of times at different angles, and finally exits the object. A scattering effect is very important for translucent objects, for example, marble, skin, tree leaves, wax, and milk. Through theoretical analysis and experimental tests, related persons find that a scattering distance between an incident point from which a light ray enters a translucent object and an emergent point from which the light ray exits the translucent object is extremely important to an impact on the scattering effect.

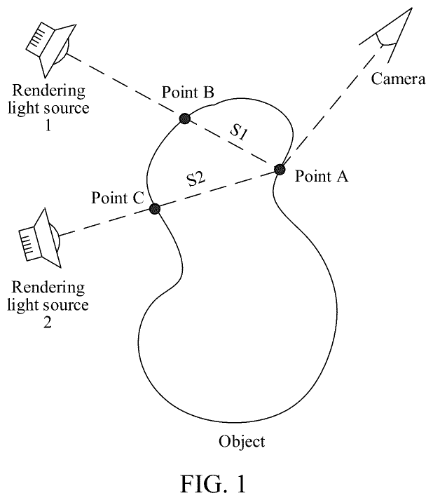

In a related technology, when image rendering for a light scattering effect is performed, scattering distances respectively corresponding to a plurality of rendering light sources corresponding to an object in a three-dimensional scene need to be first determined. The scattering distance is a distance between a light incident point of a rendering light source for the object and a light emergent point for the object. As shown in FIG. 1, a point A is a point corresponding to a pixel in an imaging plane on an object in a three-dimensional scene, and light emitted by two rendering light sources, namely, a rendering light source 1 and a rendering light source 2 is scattered from the point A. In the related technology, a scattering distance S1 between a light incident point B of the rendering light source 1 and the point A and a scattering distance S2 between a light incident point C of the rendering light source 2 and the point A need to be separately calculated, and an overall light scattering effect corresponding to the point A is determined based on the scattering distances respectively corresponding to the two rendering light sources. It can be seen that, in the related technology, a scattering distance needs to be calculated for each rendering light source, a computational load is large, and processing performance required for image rendering is high. Therefore, it is difficult to apply an image rendering technology on some devices with low processing performance, which is not conducive to promotion of an image rendering technology with a high sense of reality.

To resolve the foregoing technical problems, this application provides an image rendering method. During simulation of a real light scattering effect, a thickness of penetrating through a target object starting from a pixel in a normal direction corresponding to a camera location may be used as a scattering distance corresponding to the pixel, and pixel information corresponding to the light scattering effect on the pixel is determined based on the scattering distance and a rendering light source corresponding to the pixel. In other words, the scattering distance only needs to be calculated once for each pixel. Thicknesses of penetrating through the target object starting from the pixel at different camera locations are usually different. Therefore, different light scattering effects caused due to different scattering distances when the target object is observed from different perspectives can be simulated to some extent, thereby reducing a computational load of image rendering, reducing processing performance required for the image rendering, and improving image rendering efficiency while ensuring a sense of reality of image rendering.

The method may be performed by a computer device, and the computer device is a computer device that can perform image rendering. For example, the computer device may be a terminal device or a server. The method may be independently performed by the terminal device or the server, or may be applied to a network scene in which the terminal device communicates with the server and may be cooperatively performed by the terminal device and the server. The terminal device may be a device, for example, a mobile phone, a tablet computer, a notebook computer, a desktop computer, a smart television, or an in-vehicle terminal. The server may be understood as an application server, or may be a Web server. During actual deployment, the server may be an independent server, a cluster server, a cloud server, or the like.

For ease of understanding the technical solutions provided in the embodiments of this application, an image rendering method provided in an embodiment of this application is described below with reference to an actual application scene.

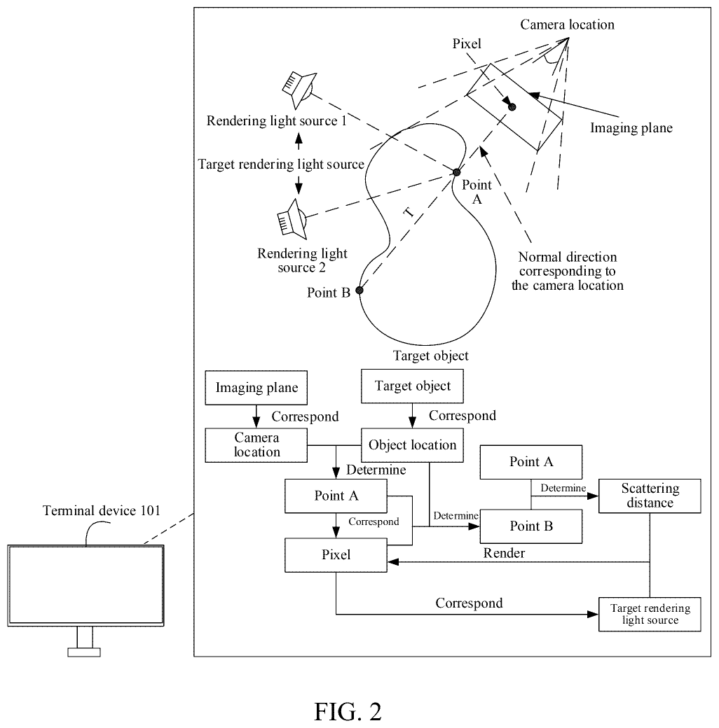

FIG. 2 is a schematic diagram showing an image rendering method in an actual application scene according to an embodiment of this application. In the actual application scene, a computer device configured to perform the image rendering method may be a terminal device 101 having an image rendering function.

In FIG. 2, the terminal device 101 may first determine a camera location of a virtual camera and an object location corresponding to a target object in a three-dimensional scene, and can determine, according to the camera location and the object location, whether a pixel in an imaging plane overlaps with the target object, that is, determine whether the pixel in the imaging plane has a corresponding visible point on the target object. As shown in FIG. 2, a pixel in the imaging plane corresponds to a point A on the target object. The point A is a first point touched when projection is performed to the target object starting from the pixel in a direction parallel to a normal direction corresponding to the camera location, and the target object is a touched first non-transparent object in this direction. In other words, the pixel in the imaging plane reflects the point A on the target object.

Then, the terminal device 101 may determine a point B on the target object according to the pixel and the point A. The point B is a last point touched when the projection is performed to the target object starting from the pixel in the direction parallel to the normal direction corresponding to the camera location. In other words, the target object is penetrated from the point A to the point B in the normal direction, which may be understood as that a distance between the point A and the point B is a thickness of the target object when the target object is presented from the pixel. The terminal device may determine the distance between the point A and the point B as a scattering distance of a target rendering light source corresponding to the pixel in the target object, and may determine a light scattering effect of the target rendering light source on the point A accordingly, to determine pixel information corresponding to the pixel, and render the pixel in the imaging plane. In the actual application scene, the target rendering light source may include a rendering light source 1 and a rendering light source 2.

Thicknesses of a target object reflected by different pixels at the same camera location are different, and thicknesses of the target object reflected by the same pixel at different camera locations are different. Therefore, scattering distances determined in this manner can conform to change effects of the scattering distances at different pixels of the same camera location and at different camera locations of the same pixel, which can conform to changes of the real light scattering effect at different locations of the target object and changes of the target object observed from different perspectives, thereby ensuring a sense of reality of image rendering. In addition, the terminal device 101 only needs to calculate the scattering distance once for the same pixel in one image rendering process, thereby reducing a computational load required for image rendering, improving image rendering efficiency, and facilitating application in a device with low processing performance.

An image rendering method provided in an embodiment of this application is described below with reference to the accompanying drawings.

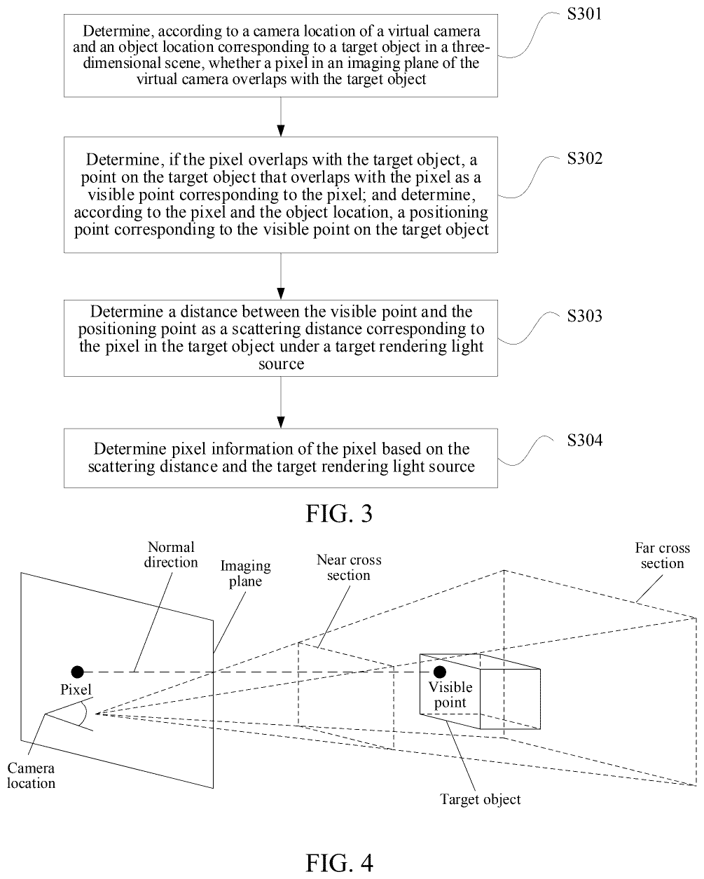

FIG. 3 is a flowchart of an image rendering method according to an embodiment of this application. The method may be performed by the foregoing computer device. The method includes the following operations:

S301: Determine, according to a camera location of a virtual camera and an object location corresponding to a target object in a three-dimensional scene, whether a pixel in an imaging plane of the virtual camera overlaps with the target object.

The camera location is a location of the virtual camera configured to generate a to-be-generated image (also referred to as a “target image”), the virtual camera may be considered as a virtual device that captures a two-dimensional image for the three-dimensional scene, the camera location of the virtual camera may be considered as a perspective for viewing the three-dimensional scene, and viewing content from the perspective is reflected through the to-be-generated image. The to-be-generated image is obtained by determining pixel information of each pixel in the imaging plane of the virtual camera. In other words, after the pixel information of each pixel in the imaging plane is determined, the to-be-generated image may be obtained.

In this embodiment of this application, a target object in the three-dimensional scene is included in a perspective of the virtual camera for a to-be-rendered three-dimensional scene (also referred to as a “target three-dimensional scene”), that is, the target object is an object that can be acquired by the virtual camera for the three-dimensional scene at the current camera location, and the target object may be a translucent object. The camera location determines, to some extent, content in the to-be-generated image that can be obtained through rendering. For example, the camera location can determine an angle, a distance, and the like at which the object is presented in the to-be-generated image. Rendering is a process of generating an image corresponding to the to-be-rendered three-dimensional scene, that is, a process of generating content for reflecting the three-dimensional scene from a perspective corresponding to the virtual camera. During rendering, the computer device needs to determine pixel information corresponding to each pixel in an imaging plane. The pixel information is configured for determining a display style of the pixel in the to-be-generated image, and may be information like a pixel value. In other words, in this embodiment of this application, the camera location needs to be first determined, and then the pixel information of each pixel in the imaging plane of the virtual camera needs to be determined, to generate the to-be-generated image corresponding to the camera location.

In this embodiment of this application, both the camera location and the object location corresponding to the target object may be determined based on a space coordinate system to which the to-be-rendered three-dimensional scene belongs, that is, the camera location and the location corresponding to the target object are determined based on the space coordinate system corresponding to the three-dimensional scene. Alternatively, a coordinate system centered on the camera location may be established in space corresponding to the three-dimensional scene, and then the object location corresponding to the target object is determined based on the coordinate system.

In this application, the computer device may separately detect whether any pixel in the imaging plane overlaps with the target object. Detecting whether the pixel overlaps with the target object is essentially detecting whether the pixel overlaps with a point on the target object in a normal direction corresponding to the camera location. Specifically, the computer device may determine, according to the camera location of the virtual camera, the normal direction corresponding to the camera location, and then determine whether a ray starting from the pixel in the normal direction intersects with the target object. If the ray intersects with the target object, and the ray does not intersect with another opaque object in the three-dimensional scene before intersecting with the target object, it may be considered that the pixel overlaps with the target object. On the contrary, if the ray does not intersect with the target object, or the ray has already intersected with another opaque object in the three-dimensional scene before intersecting with the target object, it may be considered that the pixel does not overlap with the target object.

Detecting whether the pixel in the imaging plane overlaps with the target object is essentially determining whether the pixel has a corresponding visible point on the target object. Specifically, it may be determined whether one or more non-transparent object points corresponding to the pixel exist in the normal direction corresponding to the camera location in the three-dimensional scene. If so, a non-transparent object point closest to the pixel is determined as the visible point corresponding to the pixel. For example, the computer device may determine, according to a camera location corresponding to the imaging plane, the normal direction corresponding to the camera location, that is, a direction perpendicular to a cross section corresponding to the camera location. As shown in FIG. 4, during rendering, a viewing pyramid corresponding to the camera location has a corresponding near cross section and a corresponding far cross section, and the computer device actually performs image rendering on an object between the near cross section and the far cross section in the viewing pyramid, that is, only the object between the near cross section and the far cross section can be presented in the imaging plane, and the normal direction corresponding to the camera location is perpendicular to the near cross section and the far cross section. Then, the computer device may determine, for each pixel in the imaging plane according to a location of the target object, whether one or more non-transparent object points corresponding to the pixel exist in the normal direction, that is, detect whether a ray that starts from the pixel and that has the same direction as the normal direction corresponding to the camera location intersects with the target object (that is, the non-transparent object) in the three-dimensional scene. If the ray intersects with the target object, it is determined that a visible point on the target object corresponding to the pixel exists in the imaging plane. Further, an intersection closest to the pixel in the imaging plane in all intersections may be used as the visible point on the target object corresponding to the pixel.

The object may be of one of two types: a transparent object and a non-transparent object. The non-transparent object may be further divided into a translucent object and an opaque object. In this application, rendering is performed for a scattering effect of light on the translucent object. The foregoing transparent object, translucent object, and opaque object may be determined according to material information corresponding to the object. For example, if an object is formed by a translucent material (for example, marble, skin, tree leaves, wax, or milk), the object is the translucent object. Alternatively, the foregoing transparent object, translucent object, and opaque object may be determined according to transparency information corresponding to the object. For example, a transparency range corresponding to the translucent material is preset, and if transparency of an object falls within the transparency range, the object may be considered as the translucent object.

In this embodiment of this application, the pixel is any pixel in the imaging plane, and belongs to the imaging plane. The visible point is a point on the target object in a to-be-rendered scene (also referred to as a “target scene”), and belongs to the target object. The foregoing pixel and the foregoing visible point are points in space of different dimensions. To be specific, the pixel is a point in two-dimensional imaging plane space, and the visible point is a point in a three-dimensional to-be-rendered scene. A correspondence between the pixel and the visible point may be understood as that, in the two-dimensional imaging plane, the pixel is configured for reflecting content of the corresponding visible point in the three-dimensional to-be-rendered scene.

When the visible point is located on the target object, the visible point is a point on the target object closest to the pixel, a connecting line between the visible point and the pixel is parallel to a normal line corresponding to the camera location, and a line segment formed by the visible point and the pixel does not travel through the non-transparent object. If a non-transparent object exists between the visible point and the pixel, at the camera location, the non-transparent object interferes with a lighting effect on the visible point. In this way, pixel information corresponding to the pixel actually does not reflect the lighting effect of the visible point.

In this embodiment of this application, the method provided in this embodiment of this application may be performed on each pixel in the imaging plane serially one by one, to determine pixel information corresponding to each pixel. The method provided in this embodiment of this application may alternatively be simultaneously performed on a plurality of pixels in the imaging plane in parallel, to determine pixel information respectively corresponding to the plurality of pixels. In other words, the method provided in this application may be applicable to determining pixel information corresponding to a single pixel, and may also be applicable to determining pixel information corresponding to a plurality of pixels.

S302: Determine, if the pixel overlaps with the target object, a point on the target object that overlaps with the pixel as the visible point corresponding to the pixel; and determine, according to the pixel and the object location, a positioning point corresponding to the visible point on the target object.

If it is determined through detection that the pixel overlaps with the target object, the point on the target object that overlaps with the pixel may be determined as the visible point corresponding to the pixel, that is, a point on the target object that overlaps with the pixel in the normal direction corresponding to the camera location is determined as the visible point corresponding to the pixel. Alternatively, if it is determined through detection in S301 that the pixel has the corresponding visible point on the target object, the operation of determining the positioning point corresponding to the visible point may be directly performed.

In a real scene, at different locations of the same perspective and at the same location of different perspectives, due to a fixed location of a light source, an uneven thickness of the translucent object, or the like, scattering distances of a light ray in the translucent object are different. Therefore, to simulate a light scattering effect in the real scene, the computer device needs to determine a scattering distance reflecting the foregoing change feature.

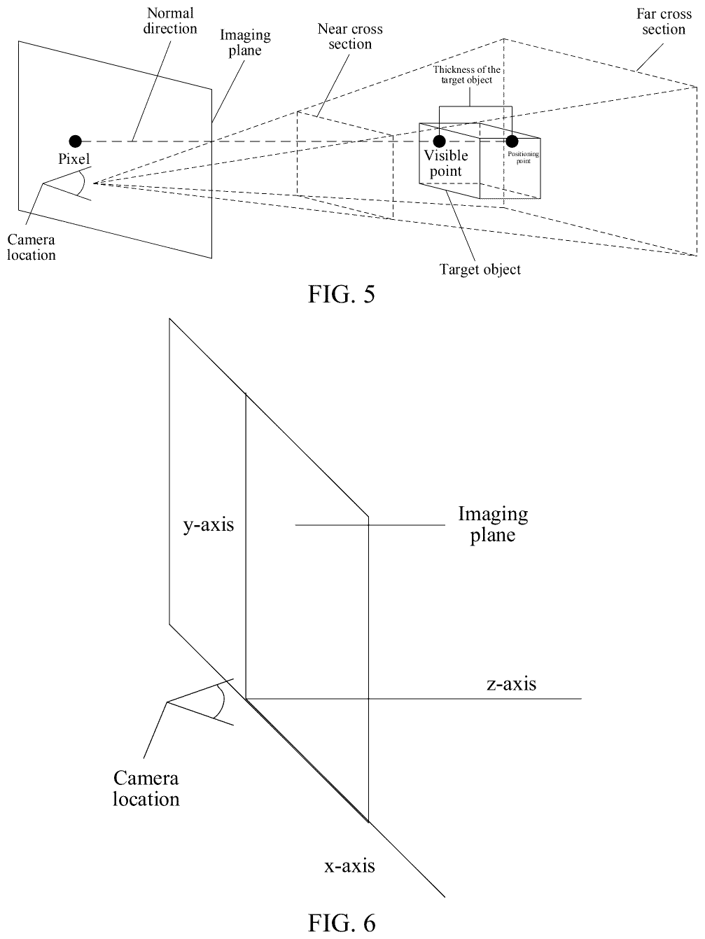

The computer device may determine the positioning point on the target object by using the pixel and the object location corresponding to the target object. The positioning point is a point farthest away from the pixel on a straight line connecting the pixel and the visible point, and the positioning point is essentially a point on the target object. To be specific, a process of determining the positioning point may be essentially considered as: determining intersections of the target object and a connecting line between the pixel and the visible point, and determining an intersection farthest away from the pixel in all intersections as the positioning point. In other words, as shown in FIG. 5, the distance between the positioning point and the visible point may be configured for representing a thickness of the target object starting from the pixel in the normal direction corresponding to the camera location. For example, the distance between the visible point corresponding to the pixel and the positioning point is a thickness corresponding to the target object when the target object is viewed from the pixel and from a perspective corresponding to the camera location.

The foregoing visible point may be understood as a first intersection of the target object and the ray that starts from the pixel and that has the same direction as the normal direction corresponding to the camera location, and the foregoing positioning point may be understood as a last intersection of the ray and the target object.

There may be a plurality of manners of determining the positioning point. For example, the computer device may determine the positioning point based on a connecting line formed by the visible point and the pixel that penetrates through the target object, or may determine the positioning point based on a connecting line determined according to the normal direction corresponding to the camera location and the pixel. This is not limited herein.

S303: Determine a distance between the visible point and the positioning point as a scattering distance corresponding to the pixel in the target object under a target rendering light source.

S304: Determine pixel information of the pixel based on the scattering distance and the target rendering light source.

The scattering distance is a required parameter configured for simulating a scattered lighting effect, configured for reflecting a scattered lighting effect of each light source on the target object in the to-be-rendered scene. The scattering distance is usually determined according to a distance between an incident point and an emergent point of a light ray emitted by each light source in the target object. In this embodiment of this application, the distance between the visible point corresponding to the pixel and the positioning point is used as the scattering distance configured for reflecting the scattered lighting effect corresponding to the pixel.

At the same camera location, because different pixels correspond to different locations, visible points and positioning points determined based on different pixels are different. Correspondingly, distances between the visible points and the positioning points corresponding to different pixels are usually different. In addition, from different camera perspectives, because the normal direction corresponding to the camera location changes, visible points and positioning points on the target object corresponding to the same pixel are different. Correspondingly, distances between the visible points and the positioning points corresponding to the same pixel usually also changes. In this embodiment of this application, a change feature of the distance between the visible point and the positioning point conforms to a change feature of the scattering distance in the actual scene. In addition, because the distance can accurately reflect an object thickness corresponding to the target object at a pixel, a change of the scattering distance conforms to an object feature of the target object. In this way, the distance between the visible point and the positioning point is used as the scattering distance, and rendering of the lighting effect is performed accordingly, so that a high sense of reality can be obtained.

Based on this, the computer device may determine the distance between the visible point and the positioning point as the scattering distance corresponding to the pixel in the target object under the target rendering light source, and determine the pixel information of the pixel based on the scattering distance and the target rendering light source. The target rendering light source is a light source that can affect the lighting effect corresponding to the pixel. In this manner, the computer device does not need to determine a light incident point and a light emergent point of each target rendering light source on the target object, and only needs to calculate the scattering distance once for one pixel, thereby greatly reducing a computational load required for light rendering. The pixel information is configured for rendering the pixel in the imaging plane, and may be, for example, information like a pixel value corresponding to the pixel. In the foregoing manner, the computer device can determine pixel information respectively corresponding to a plurality of pixels included in the imaging plane, to obtain the to-be-generated image through rendering.

It can be seen from the foregoing technical solutions that, when rendering is performed on an object on which a light scattering effect needs to be considered, whether a pixel in an imaging plane of a virtual camera overlaps with a target object in a three-dimensional scene may be first determined according to a camera location of the virtual camera and an object location corresponding to the target object. If the pixel overlaps with the target object, it indicates that the target object is a first non-transparent object seen through the pixel in the imaging plane from a perspective corresponding to the camera location. Then, a point on the target object that overlaps with the pixel may be determined as a visible point corresponding to the pixel, and a positioning point corresponding to the visible point on the target object is determined according to the pixel and the object location corresponding to the target object. The positioning point is a point farthest away from the pixel on a straight line connecting the pixel and the visible point. In other words, the target object can be penetrated through starting from the pixel in a direction parallel to a normal line of the camera location based on the visible point and the positioning point. A scattering distance of light in the target object is a key factor for simulating a real light scattering effect. The pixel corresponds to different points on the target object at different camera locations, and when different points on the target object are used as light emergent points, distances between light incident points and the light emergent points are different. Therefore, in an actual case, when pixel information of the pixel is determined at different camera locations, scattering distances of light in the target object are different, so that an image presenting different lighting effects can be obtained through rendering based on different camera locations. It can be seen that, to simulate the real light scattering effect, the scattering distances at different camera locations need to be determined. In this application, when the target object is penetrated through starting from the pixel at different camera locations, thicknesses corresponding to the target object are different. Therefore, penetrating distances that can reflect the thicknesses are used as scattering distances, which can simulate a difference effect of the scattering distances at different camera locations to some extent. In other words, in this application, the distance between the visible point and the positioning point may be determined as a scattering distance corresponding to the pixel in the target object under a target rendering light source, and then the pixel information of the pixel is determined based on the scattering distance and the target rendering light source. In this way, the corresponding scattering distance does not need to be determined starting from each rendering light source, and the scattering distance only needs to be calculated once based on each pixel, thereby realistically simulating the light scattering effect. In this way, while a sense of reality of image rendering is ensured, a computational load required for image rendering is reduced, processing pressure of image rendering is reduced, and image rendering efficiency is improved. Therefore, a requirement of an image rendering technology with a high sense of reality on device processing performance can be reduced, so that the image rendering technology with the high sense of reality can run on a device with a low processing capability, thereby facilitating promotion of the image rendering technology with the high sense of reality.

Because the visible point is a point closest to the pixel in the normal direction at the camera location, the point is usually located on a visible surface of the target object with respect to the virtual camera. Usually, when the visible point is determined, the computer device needs to determine, based on location information of each point on the target object, whether each point is located in the normal direction of the pixel. Determining the location information of the point on the target object usually requires the computer device to consume a particular computational load. Therefore, in a possible implementation, to further reduce the computational load required for image rendering and reduce a performance requirement on the computer device, the computer device may determine the visible point only with reference to a location of a point on the visible surface corresponding to the target object.

When operation S302 is performed, the computer device may perform operation S3021 to operation S3023 (not shown in the figure), where operation S3021 to operation S3023 are a possible implementation of operation S302.

S3021: Determine, according to the camera location and the object location, a visible surface of the target object with respect to the camera location.

The computer device may determine the visible surface of the target object with respect to the virtual camera through back-face culling or the like. The visible surface is a surface of the target object included in the imaging plane, that is, a surface of the target object acquired by the virtual camera at the current camera location. When the target object includes a plurality of surfaces, if the target object is a unique object in a to-be-rendered three-dimensional scene, the visible surface is a surface included in the imaging plane, and the three-dimensional scene is a scene presented through the imaging plane. In other words, if no other object blocks the visible surface during rendering, the visible surface can be presented in the imaging plane. In other words, if no other object blocks the visible surface, the following pixel exists in the imaging plane: a point intersecting with the target object for the first time is located on the visible surface when the pixel is used as a start point and extension is performed in the normal direction of the camera location.

S3022: Determine, according to the camera location and the object location, a location corresponding to the pixel and locations respectively corresponding to a plurality of points on the visible surface.

The computer device may obtain a point location for the visible surface. For example, after the back-face culling is started, the location corresponding to the pixel and the locations respectively corresponding to the plurality of points on the visible surface may be determined by starting depth write and a depth test. The plurality of points on the visible surface herein may be all points included in the visible surface. An objective of determining a location based on the camera location and the object location corresponding to the target object is to convert locations of the points on the visible surface and the pixel (where the location of the pixel may be understood as a location of the pixel in the imaging plane corresponding to the virtual camera) into the same location measurement system, thereby facilitating positioning of the visible point on the visible surface. The depth write is a buffer of a floating point number in a unit of pixels, to save a pixel depth value. A depth buffer is configured for limiting a rendering region. The depth test is performing a comparison test of a depth value of the current pixel and the pixel value in the depth buffer, and if the test fails, the current pixel is discarded. The depth value is usually a value on a z-axis in a camera coordinate system.

S3023: Determine the visible point from the plurality of points according to the location corresponding to the pixel and locations respectively corresponding to the plurality of points on the visible surface.

Based on the locations respectively corresponding to the points, the computer device may determine, in the plurality of points, a point whose connecting line to the pixel is parallel to the normal line corresponding to the camera location and which is closest to the pixel as the visible point.

In this embodiment of this application, when the visible point is determined, only a location of a point on the visible surface needs to be determined, and a location corresponding to each point on the target object does not need to be determined, thereby greatly reducing a computational load required for determining the location of the visible point, and further improving image rendering efficiency.

As described above, an objective of determining the locations of the pixel and the plurality of points on the visible surface based on the camera location and the object location corresponding to the target object is to convert the locations of the points on the visible surface and the pixel into the same location measurement system. In a possible implementation, when operation S3022 is performed, the computer device may perform operation S30221 and operation S30222 (not shown in the figure), where operation S30221 and operation S30222 are a possible implementation of operation S3022.

S30221: Establish a space coordinate system corresponding to the camera location.

As shown in FIG. 6, an origin of the space coordinate system is the camera location, a z-axis of the space coordinate system is a camera optical axis corresponding to the camera location, and a plane formed by an x-axis and a y-axis of the space coordinate system is the imaging plane.

S30222: Determine, according to the space coordinate system and the object location, a coordinate location of the pixel in the space coordinate system as the location corresponding to the pixel, and determine coordinate locations of the plurality of points on the visible surface in the space coordinate system as the locations respectively corresponding to the plurality of points.

The computer device may convert the location of each point on the visible surface of the target object into the space coordinate system based on a location relationship between the space coordinate system and the object location corresponding to the target object, to obtain the location corresponding to each point.

When operation S3023 is preformed, the computer device may perform operation S30231 (not shown in the figure), where operation S30231 is a possible implementation of operation S3023.

S30231: Determine, in the plurality of points, a point whose corresponding x-axis coordinate is the same as an x-axis coordinate of the pixel, whose corresponding y-axis coordinate is the same as a y-axis coordinate of the pixel, and whose corresponding z-axis coordinate is closest to a z-axis coordinate of the pixel as the visible point.

In the space coordinate system, because the normal direction is a direction of the z-axis, and the x-axis and the y-axis form the imaging plane, if an x-axis coordinate and a y-axis coordinate of a point are the same as the x-axis coordinate and the y-axis coordinate of the pixel, it indicates that a connecting line between the two points is parallel to the z-axis, that is, parallel to the normal line. For a point whose z-axis coordinate is closest to the z-axis coordinate of the pixel, it indicates that the point is closest to the pixel. Usually, the z-axis coordinate of the pixel is 0, and a point whose z-axis coordinate is closer to 0 on the visible surface is closer to the pixel. In this manner, in the same space coordinate system, the visible point on the target object corresponding to the pixel can be quickly and accurately positioned.

As described above, in this application, the reason why the distance between the visible point and the positioning point is used as the scattering distance is that the distance can conform to a change feature of the scattering distance corresponding to the target object in various cases, and can also reflect a thickness change of the target object from different perspectives and at different locations. Therefore, when the positioning point is determined, the computer device needs to ensure that the positioning point is also a point on the target object.

During rendering, when the location of each point on the target object is determined, the computer device actually detects the location of each point starting from the pixel in a direction parallel to the normal direction. If there is only one object, namely, the target object, in the to-be-rendered three-dimensional scene corresponding to the imaging plane, the computer device may pay no attention to objects to which object points belong. If there is another object, the computer device may distinguish between objects to which object points belong.

When operation S303 is performed, the computer device may perform operation S3031 and operation S3032 (not shown in the figure), where operation S3031 and operation S3032 are a possible implementation of operation S303.

S3031: Determine, according to the pixel and the object location corresponding to the target object, a plurality of to-be-determined points (also referred to as “candidate points”) that are included in the target object and located on a straight line connecting the pixel and the visible point.

The computer device may first determine the plurality of to-be-determined points that are located on the target object and whose connecting lines to the pixel are parallel to the normal direction. The plurality of to-be-determined points usually include the visible point and the positioning point.

S3032: Determine a to-be-determined point farthest away from the pixel in the plurality of to-be-determined points as the positioning point.

In this way, the computer device may ensure that the distance between the positioning point and the visible point can accurately reflect a thickness feature of the target object under the pixel, so that the scattering distance determined in the foregoing manner can reflect the thickness of the target object, thereby simulating a change feature of an actual scattering distance.

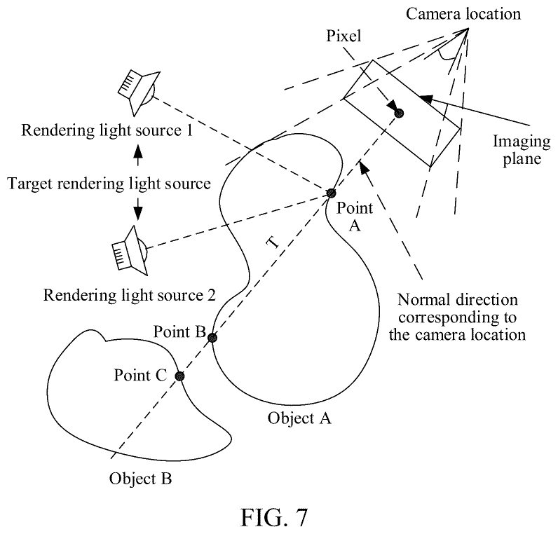

As shown in FIG. 7, a target object is an object A, a visible point is a point A, and light starting from a pixel in a normal direction corresponding to a camera location may intersect with a point C on an object B. However, a distance between the point C and the point A cannot reflect a real thickness of the object A. Therefore, a point B that belongs to the object A and that is farthest away from the pixel in the normal direction may be determined in this manner, and the point B is a positioning point of the pixel on the object A.

In this way, the positioning point on the target object corresponding to the pixel is accurately determined in the foregoing manner, to ensure that the distance between the visible point and the positioning point can accurately reflect the thickness of the target object corresponding to the pixel, that is, can accurately reflect a scattering distance corresponding to the pixel, thereby facilitating improvement of a sense of reality of an image rendering effect.

There may be a plurality of manners of determining points belonging to the same target object. In a possible implementation, the target object is any one of a plurality of objects, and the plurality of objects is a plurality of objects in the three-dimensional scene corresponding to the imaging plane. In other words, the imaging plane needs to reflect the plurality of objects in the three-dimensional scene.

The computer device may determine, according to the object location corresponding to the target object, a plurality of object points included in the target object, and then add an object identifier corresponding to the target object to the plurality of object points. By using the object location corresponding to the target object, the computer device may determine information, for example, a size and a positioning point of the target object in space, to determine a region occupied by a point on the target object in the space, thereby determining the plurality of object points on the target object. The object identifier is configured for identifying that an object point belongs to the target object.

When operation S3031 is performed, the computer device may perform operation S30311 and operation S30312 (not shown in the figure), where operation S30311 and operation S30312 are a possible implementation of operation S3031.

S30311: Determine, according to the pixel and object locations respectively corresponding to the plurality of objects, a plurality of initial to-be-determined points that are included in the plurality of objects and located on the straight line connecting the pixel and the visible point.

First, the computer device may determine, according to the pixel, a straight line that passes through the pixel and that is parallel to the normal direction, determine, with reference to the object locations respectively corresponding to the plurality of objects, points that are on the plurality of objects and that are respectively located on the straight line, and use the points as the initial to-be-determined points.

S30312: Determine the plurality of initial to-be-determined points having the object identifier as the plurality of to-be-determined points.

Because the object identifier can identify the target object, a point having the object identifier is a point on the target object. The computer device may determine the plurality of initial to-be-determined points having the object identifier as the plurality of to-be-determined points, to subsequently determine the positioning point. In this way, the to-be-determined points belonging to the target object are conveniently and quickly determined in the foregoing manner.

In addition, there may be a plurality of manners of determining the pixel information based on the scattering distance and a rendering light source. Specifically, in a possible implementation, the computer device may determine the pixel information with reference to a lighting manner of the target rendering light source for the target object.

When operation S304 is performed, the computer device may perform operation S3041 and operation S3042 (not shown in the figure), where operation S3041 and operation S3042 are a possible implementation of operation S304.

S3041: Determine a light source parameter corresponding to the target rendering light source.

The light source parameter is configured for identifying the lighting manner of the target rendering light source for the target object.

S3042: Determine the pixel information corresponding to the pixel according to the scattering distance and the light source parameter.

Based on the light source parameter, the computer device can determine a lighting effect when the target rendering light source shines on the target object. Based on the scattering distance, the computer device can analyze a lighting effect attenuation situation when the target rendering light source is scattered on the target object, to simulate a lighting effect of the visible point on the target object after the visible point is penetrated through and shone by the target rendering light source, and further determine the pixel information of the pixel corresponding to the visible point in the imaging plane.

When the pixel information (for example, a pixel value) corresponding to each pixel in the imaging plane is calculated, the pixel information corresponding to each pixel may be calculated by using a rendering function in image rendering software according to the scattering distance corresponding to each pixel in the imaging plane and the light source parameter of the target rendering light source. The rendering function used herein may include, but is not limited to, imageColSize( ), SetPixel( ), and the like.

In this way, in the foregoing manner, a light rendering effect of the target rendering light source on the target object is simulated based on the light source parameter corresponding to the target rendering light source and the scattering distance, thereby facilitating improvement of a sense of reality of the light rendering effect obtained through simulation.

To improve flexibility and diversity of the light rendering effect, in a possible implementation, the computer device may alternatively support diversified lighting effect requirements by using some adjustable parameters.

The computer device may provide an adjustable lighting effect parameter. The lighting effect parameter is configured for adjusting the lighting effect of the target rendering light source on the pixel, for example, may be configured for adjusting an aggregation degree between a plurality of light rays penetrating through the visible point, a change degree of a lighting effect changing as a lighting distance changes, and the like. If a user intends to adjust a lighting effect for a pixel, the user may input a corresponding lighting effect parameter for the pixel.

The computer device may obtain the lighting effect parameter corresponding to the pixel. When operation S3042 is performed, the computer device may perform operation S30421 (not shown in the figure), where operation S30421 is a possible implementation of operation S3042.

S30421: Determine the pixel information corresponding to the pixel according to the scattering distance, the light source parameter, and the lighting effect parameter.

According to the scattering distance and the light source parameter, the computer device can simulate a lighting effect corresponding to the visible point when the lighting effect is not adjusted. With reference to the lighting effect parameter, the computer device can adjust the lighting effect corresponding to the visible point when the target rendering light source penetrates through the target object based on an actual lighting requirement, to adjust the lighting effect corresponding to the pixel, that is, the pixel information corresponding to the pixel.

In a case of a new lighting effect parameter, initial pixel information corresponding to each pixel may be first calculated by using the rendering function in the image rendering software according to the scattering distance corresponding to each pixel in the imaging plane and the light source parameter of the target rendering light source. Then, the pixel information corresponding to each pixel in the imaging plane after the lighting effect is adjusted is re-determined by using a lighting effect adjustment function in the image rendering software according to the lighting effect parameter and the initial pixel information corresponding to each pixel in the imaging plane.

In this way, in the foregoing manner, the pixel information of the pixel is determined based on the scattering distance, the light source parameter, and the lighting effect parameter, so that a requirement on the lighting effect can be adjusted more flexibly, thereby generating an imaging plane that better satisfies a user requirement, and improving flexibility and diversity of the imaging plane.

The light source parameter includes at least one of the following: a light source location parameter and a light source direction parameter. The light source location parameter is configured for identifying a light source location corresponding to the target rendering light source, and the light source direction parameter is configured for identifying a light source direction of the target rendering light source. The lighting effect parameter includes at least one of the following: an offset parameter, an aggregation degree parameter, and a change parameter. The offset parameter is configured for adjusting the light source direction of the target rendering light source, that is, a direction that the target rendering light source shines on the target object. The aggregation degree parameter is configured for adjusting an aggregation degree between a plurality of lighting effects presented through the pixel, for example, there may be a plurality of light rays penetrating through the visible point after being scattered, and the aggregation degree parameter may be configured for controlling the aggregation degree between the plurality of light rays. The change parameter is configured for adjusting a change degree of the lighting effect changing as a shining distance changes, for example, an enhanced degree of the lighting effect enhanced as the shining distance changes, or an attenuation degree of the lighting effect attenuated as the shining distance changes. The shining distance is a distance between the target rendering light source and the target object.

In addition to supporting the user to adjust the lighting effect, the computer device may further support the user in adjusting an overall presentation effect of the imaging plane. The overall presentation effect is an effect of presenting the imaging plane, and may include, for example, an anti-aliasing effect, a color grading effect, and a tone mapping effect.

In a possible implementation, if the user intends to adjust the presentation effect corresponding to the imaging plane to obtain a to-be-generated image having a corresponding effect, the user may perform an effect adjustment operation on the imaging plane. The effect adjustment operation is configured for adjusting the presentation effect corresponding to the to-be-generated image. The computer device may obtain the effect adjustment operation for the imaging plane, and then adjust the pixel information of the pixel according to the effect adjustment operation, to obtain the to-be-generated image. For example, the computer device may determine adjustment parameters corresponding to the effect adjustment operation, for example, a color parameter and an anti-aliasing parameter, and adjust a final image presentation effect based on the parameters, to enrich rendering richness of the to-be-generated image and satisfy more diversified image rendering requirements.

In a to-be-rendered three-dimensional scene corresponding to the imaging plane, an opaque object may be further included in addition to the translucent target object. In a possible implementation, before rendering the target object, the computer device may first render the opaque object in the to-be-rendered scene. This rendering manner has two advantages. In one aspect, with respect to a camera location, if the opaque object is in front of the translucent target object, rendering of the target object does not interfere with rendering of the opaque object. This is because the opaque object is certainly presented in the imaging plane. In the other aspect, if the opaque object is located behind the translucent target object, the target object is rendered after the opaque object is rendered. Rendering may be directly performed, and a blocking effect of the opaque object is not considered, so that rendering is convenient, and a presentation effect of the opaque object behind the translucent object is also conveniently determined.

Based on this, in this implementation, the to-be-rendered scene corresponding to the imaging plane may include a plurality of objects. The plurality of objects include the translucent object (that is, the target object) and the opaque object. Before determining, according to the camera location of the virtual camera and the object location corresponding to the target object in the three-dimensional scene, whether the pixel in the imaging plane of the virtual camera overlaps with the target object, the computer device may first determine the opaque object in the three-dimensional scene corresponding to the imaging plane.

The computer device may determine, according to the object location corresponding to the opaque object and the camera location, a to-be-rendered opaque object (also referred to as a “target opaque object”) corresponding to the opaque object in the imaging plane, for example, a stone, a desk, or metal. The imaging plane is configured for presenting the to-be-rendered opaque object, that is, the to-be-rendered opaque object is an opaque object reflected through the imaging plane. Through this operation, the computer device may remove some opaque objects that cannot be reflected through the imaging plane, thereby avoiding ineffective rendering. For example, some opaque objects that are completely blocked by other opaque objects at the camera location may be removed.

The computer device may render the to-be-rendered opaque object in the imaging plane according to the camera location and an object location corresponding to the to-be-rendered opaque object, thereby further improving image rendering efficiency by optimizing rendering logic while ensuring an image rendering effect.

For ease of understanding the technical solutions provided in the embodiments of this application, an image rendering method provided in an embodiment of this application is described below with reference to an actual application scene.

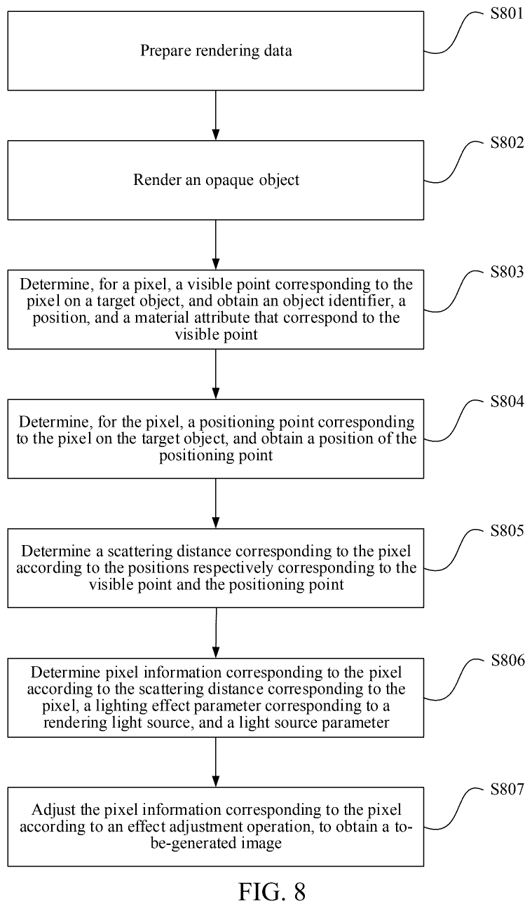

FIG. 8 is a flowchart of an image rendering method in an actual application scene according to an embodiment of this application. The method includes:

S801: Prepare rendering data.

A computer device may traverse objects in an entire to-be-rendered scene, and prepare the rendering data, such as location information about the objects and information about a camera location.

S802: Render an opaque object.

S803: Determine, for a pixel, a visible point on a target object corresponding to the pixel, and obtain an object identifier, a location, and a material attribute that correspond to the visible point.

The computer device may first close back-face culling, start depth write and a depth test, and traverse each translucent object from the camera location. Each screen pixel is used as a pixel, a translucent object point closest to the pixel in a normal direction is determined as a visible point corresponding to the pixel, an object identifier corresponding to the translucent object is recorded and written into a stencil buffer, and a location (for example, a depth value) corresponding to the visible point and a material attribute corresponding to the translucent object are written into a memory.

S804: Determine, for the pixel, a positioning point on the target object corresponding to the pixel, and obtain a location of the positioning point.

The computer device may close the back-face culling, the depth write, and the depth test, and then start stencil buffer write and a stencil buffer test. The stencil buffer write is a buffer of an integer value in a unit of pixels, and a value with a length of one byte is usually allocated to each pixel. The stencil buffer is configured for limiting a rendering region. In this embodiment of this application, the corresponding object identifier may be written into a point on the translucent object through the stencil buffer write. The stencil buffer test is a comparison test of a stencil value of the current pixel with a value of a pixel sucked in the stencil buffer. If the test fails, the current pixel is discarded. In other words, if the point does not have the object identifier, the point is not determined as the positioning point. In this manner, the computer device may find the positioning point belonging to the same translucent object as the visible point, and write the location (for example, the depth value) corresponding to the positioning point into the memory.

S805: Determine a scattering distance corresponding to the pixel according to the locations respectively corresponding to the visible point and the positioning point.

S806: Determine pixel information corresponding to the pixel according to the scattering distance corresponding to the pixel, a light source parameter corresponding to a target rendering light source, and a lighting effect parameter.

A longer light scattering distance indicates a weaker light scattering effect. A location and an orientation of a camera and a location of light all affect a lighting effect. A specific scattering effect calculation procedure is as follows:
1. Perform offset processing on a light scattering direction according to a normal direction corresponding to a light source.

The computer device may offset, based on an offset parameter in the obtained lighting effect parameter, the light direction according to an actual requirement.

2. Calculate an included angle between a normal direction corresponding to the camera location and the light scattering direction, and control an aggregation degree of a light scattering effect by using an aggregation degree parameter.

3. Adjust intensity of the light scattering effect according to the scattering distance.

Specific calculation formulas are as follows:

$$vLTLight = vLight + vNormal * fLTDistortion ;$$

$$fLTDot = pow ( saturate ( dot ( vEye , - vLTLight ) ) , fLTPower ) * fLTScale ;$$

$$fLT = fLightAttenuation * fLTDot * fLTThickness ; and$$

$$cLT = cDiffuseAlbedo * cLightDiffuse * fLT .$$

vLight represents a direction of light, and vNormal represents a normal line on a lighting effect point. fLTDistortion is an offset factor (that is, the offset parameter) between 0.0 and 1.0. vEye is the normal direction corresponding to the camera location, vLTLight is the light scattering direction, fLTPower is an aggregation degree factor (that is, the aggregation degree parameter), and fLTScale is a scattering effect intensity adjustment factor, configured for adjusting the light scattering effect during scattering. pow is a power of 2, saturate truncates a result in a range from 0 to 1, and dot represents point multiplication of two vectors. fLTThickess is the scattering distance of the light inside the object, and fLightAttenuation is an attenuation factor (that is, an attenuation parameter) of the light when the light reaches a surface of the object. cDiffuseAlbedo is a surface color of the object, and cLightDiffuse is light intensity and color values.

S807: Adjust the pixel information corresponding to the pixel according to an effect adjustment operation, to obtain a to-be-generated image.

After all objects in the to-be-rendered scene are rendered, the computer device may perform, based on the obtained effect adjustment operation, some effect post-processing on the pixel information obtained through rendering, such as anti-aliasing, color grading, and tone mapping, and then display and obtain the final to-be-generated image on a screen.

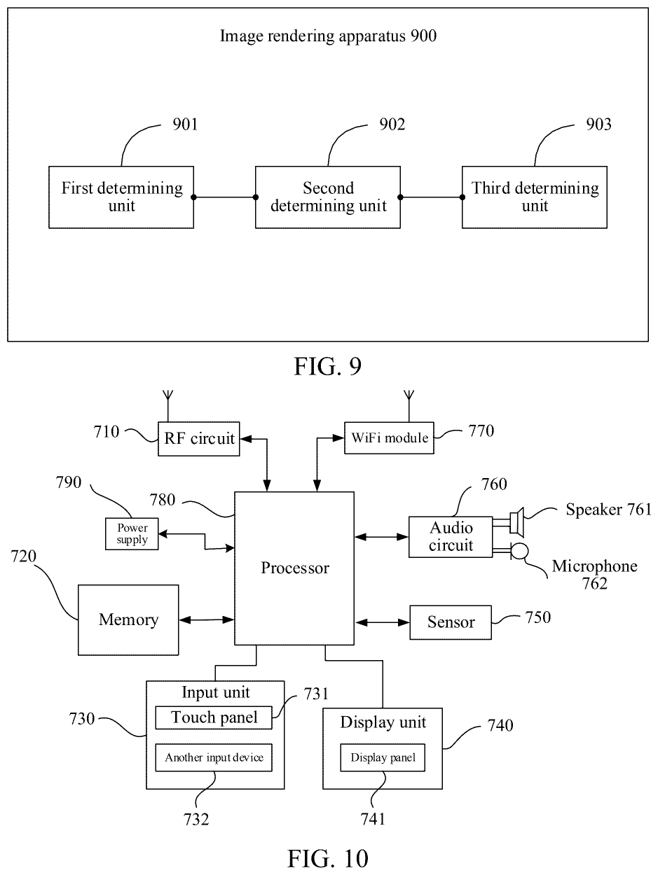

Based on the image rendering method provided in the foregoing embodiments, an embodiment of this application further provides an image rendering apparatus. FIG. 9 is a structural block diagram of an image rendering apparatus 900 according to an embodiment of this application. The image rendering apparatus 900 includes a first determining unit 901, a second determining unit 902, and a third determining unit 903.

The first determining unit 901 is configured to determine, according to a camera location of a virtual camera and an object location corresponding to a target object in a three-dimensional scene, whether a pixel in an imaging plane of the virtual camera overlaps with the target object.

The second determining unit 902 is configured to determine, if the pixel overlaps with the target object, a point on the target object that overlaps with the pixel as a visible point corresponding to the pixel; and determine, according to the pixel and the object location, a positioning point corresponding to the visible point on the target object, the positioning point being a point farthest away from the pixel on a straight line connecting the pixel and the visible point.

The third determining unit 903 is configured to determine a distance between the visible point and the positioning point as a scattering distance corresponding to the pixel in the target object under a target rendering light source, and determine pixel information of the pixel based on the scattering distance and the target rendering light source.

In a possible implementation, the first determining unit 901 is specifically configured to:
determine, according to the camera location and the object location, a visible surface of the target object with respect to the camera location, the visible surface being a surface of the target object acquired by the virtual camera at the camera location;
determine, according to the camera location and the object location, a location corresponding to the pixel and locations respectively corresponding to a plurality of points on the visible surface; and
determine the visible point from the plurality of points according to the location corresponding to the pixel and the locations respectively corresponding to the plurality of points on the visible surface.

In a possible implementation, the first determining unit 901 is specifically configured to:
establish a space coordinate system corresponding to the camera location, an origin of the space coordinate system being the camera location, a z-axis of the space coordinate system being a camera optical axis corresponding to the camera location, and a plane formed by an x-axis and a y-axis of the space coordinate system being the imaging plane;
determine, according to the space coordinate system and the object location, a coordinate location of the pixel in the space coordinate system as the location corresponding to the pixel, and determine coordinate locations of the plurality of points on the visible surface respectively in the space coordinate system as the locations respectively corresponding to the plurality of points; and
determine, in the plurality of points, a point whose corresponding x-axis coordinate is the same as an x-axis coordinate of the pixel, whose corresponding y-axis coordinate is the same as a y-axis coordinate of the pixel, and whose corresponding z-axis coordinate is closest to a z-axis coordinate of the pixel as the visible point.

In a possible implementation, the second determining unit 902 is specifically configured to:
determine, according to the pixel and the object location, a plurality of to-be-determined points that are included in the target object and located on the straight line connecting the pixel and the visible point; and
determine a to-be-determined point farthest away from the pixel in the plurality of to-be-determined points as the positioning point.

In a possible implementation, the target object is any one of a plurality of objects included in the three-dimensional scene corresponding to the imaging plane, and the apparatus further includes a fourth determining unit and an addition unit.

The fourth determining unit is configured to determine, according to the object location corresponding to the target object, a plurality of object points included in the target object.

The addition unit is configured to add an object identifier corresponding to the target object to the plurality of object points.

The second determining unit 902 is specifically configured to:
determine, according to the pixel and object locations respectively corresponding to the plurality of objects, a plurality of initial to-be-determined points that are included in the plurality of objects and located on the straight line connecting the pixel and the visible point; and
determine the plurality of initial to-be-determined points having the object identifier as the plurality of to-be-determined points.

In a possible implementation, the third determining unit 903 is specifically configured to:
determine a light source parameter corresponding to the target rendering light source, the light source parameter being configured for identifying a lighting manner of the target rendering light source for the target object; and
determine the pixel information corresponding to the pixel according to the scattering distance and the light source parameter.

In a possible implementation, the apparatus further includes a first obtaining unit.

The first obtaining unit is configured to obtain a lighting effect parameter corresponding to the pixel, the lighting effect parameter being configured for adjusting a lighting effect of the target rendering light source on the pixel.

The third determining unit 903 is specifically configured to:
determine the pixel information corresponding to the pixel according to the scattering distance, the light source parameter, and the lighting effect parameter.

In a possible implementation, the light source parameter includes at least one of the following: a light source location parameter and a light source direction parameter, where the light source location parameter is configured for identifying a light source location corresponding to the target rendering light source, and the light source direction parameter is configured for identifying a light source direction of the target rendering light source; and
the lighting effect parameter includes at least one of the following: an offset parameter, an aggregation degree parameter, and a change parameter, where the offset parameter is configured for adjusting the light source direction of the target rendering light source, the aggregation degree parameter is configured for adjusting an aggregation degree between a plurality of lighting effects presented through the pixel, the change parameter is configured for adjusting a change degree of a lighting effect changing as a shining distance changes, and the shining distance is a distance between the target rendering light source and the target object.

In a possible implementation, the target object is a translucent object, and the apparatus further includes a fifth determining unit, a sixth determining unit, and a rendering unit.

Before it is determined, according to the camera location of the virtual camera and the object location corresponding to the target object in the three-dimensional scene, whether the pixel in the imaging plane of the virtual camera overlaps with the target object, the fifth determining unit is configured to determine an opaque object in the three-dimensional scene.

The sixth determining unit is configured to determine, according to an object location corresponding to the opaque object and the camera location, a to-be-rendered opaque object corresponding to the opaque object in the imaging plane.

The rendering unit is configured to render the to-be-rendered opaque object in the imaging plane according to the camera location and an object location corresponding to the to-be-rendered opaque object.

In a possible implementation, the apparatus further includes a second obtaining unit and an adjustment unit.

The second obtaining unit is configured to obtain an effect adjustment operation for the imaging plane, the effect adjustment operation being configured for adjusting a presentation effect of the target object in the imaging plane.

The adjustment unit is configured to adjust the pixel information of the pixel according to the effect adjustment operation, to obtain a to-be-generated image.

An embodiment of this application further provides a computer device. Referring to FIG. 10, the computer device may be a terminal device. The terminal device is, for example, a mobile phone.

FIG. 10 shows a block diagram of a partial structure of a mobile phone according to an embodiment of this application. Referring to FIG. 10, the mobile phone includes components such as: a radio frequency (RF) circuit 710, a memory 720, an input unit 730, a display unit 740, a sensor 750, an audio circuit 760, a wireless fidelity (WiFi) module 770, a processor 780, and a power supply 790. A person skilled in the art may understand that the structure, shown in FIG. 10, of the mobile phone does not constitute a limitation on the mobile phone, and the mobile phone may include more or fewer components than those shown in the figure, or a combination of some components, or a different component deployment may be used.

The following specifically describes the components of the mobile phone with reference to FIG. 10.

The RF circuit 710 may be configured to transmit signals during transmitting information or a call process, particularly, after receiving downlink information from a base station, deliver the downlink information to the processor 780 for processing, and in addition, send design uplink data to the base station. Generally, the RF circuit 710 includes, but not limited to, an antenna, at least one amplifier, a transceiver, a coupler, a low noise amplifier (LNA), and a duplexer. In addition, the RF circuit 710 may also communicate with a network and another device by wireless communication. The wireless communication may use any communication standard or protocol, including, but not limited to, global system of mobile communications (GSM), general packet radio service (GPRS), code division multiple access (CDMA), wideband code division multiple access (WCDMA), long term evolution (LTE), email, short messaging service (SMS), and the like.

The memory 720 may be configured to store a software program and a module. The processor 780 runs the software program and the module that are stored in the memory 720, to perform various functional applications and data processing of the mobile phone. The memory 720 may mainly include a program storage region and a data storage region. The program storage region may store an operating system, an application required by at least one function (for example, a sound playback function and an image display function), and the like. The data storage region may store data (for example, audio data and an address book) created according to the use of the mobile phone, and the like. In addition, the memory 720 may include a high speed random access memory, and may further include a non-volatile memory, for example, at least one magnetic disk storage device, a flash memory, or another volatile solid-state storage device.

The input unit 730 may be configured to receive inputted digit or character information, and generate a keyboard signal input related to user settings and function control of the mobile phone. Specifically, the input unit 730 may include a touch panel 731 and another input device 732. The touch panel 731, also referred to as a touchscreen, may collect a touch operation of a user on or near the touch panel 731 (for example, an operation of the user on or near the touch panel 731 by using any suitable object or accessory such as a finger or a stylus), and drive a corresponding connection apparatus according to a preset program. In some embodiments, the touch panel 731 may include two parts: a touch detection apparatus and a touch controller. The touch detection apparatus detects a touch orientation of the user, detects a signal generated by the touch operation, and transmits the signal to the touch controller. The touch controller receives touch information from the touch detection apparatus, converts the touch information into touch point coordinates, and transmits the touch point coordinates to the processor 780. Moreover, the touch controller may receive and execute a command transmitted from the processor 780. In addition, the touch panel 731 may be implemented by using various types, such as a resistive type, a capacitance type, an infrared type, and a surface acoustic wave type. In addition to the touch panel 731, the input unit 730 may further include the another input device 732. Specifically, the another input device 732 may include, but is not limited to, one or more of a physical keyboard, a functional key (for example, a volume control key or a switch key), a track ball, a mouse, and a joystick.

The display unit 740 may be configured to display information inputted by a user or information provided for the user, and various menus of the mobile phone. The display unit 740 may include a display panel 741. In some embodiments, the display panel 741 may be configured in the form of a liquid crystal display (LCD), an organic light-emitting diode (OLED), or the like. In addition, the touch panel 731 may cover the display panel 741. After detecting the touch operation performed on or near the touch panel 731, the touch panel 731 transmits the touch operation to the processor 780, to determine a type of a touch event. Then, the processor 780 provides corresponding visual output on the display panel 741 according to the type of the touch event. Although in FIG. 10, the touch panel 731 and the display panel 741 are configured as two separate parts to implement input and output functions of the mobile phone, in some embodiments, the touch panel 731 and the display panel 741 may be integrated to implement the input and output functions of the mobile phone.

The mobile phone may further include at least one sensor 750 for example, an optical sensor, a motion sensor, and other sensors. Specifically, the optical sensor may include an ambient light sensor and a proximity sensor. The ambient light sensor may adjust luminance of the display panel 741 according to brightness of the ambient light. The proximity sensor may switch off the display panel 741 and/or backlight when the mobile phone is moved to the ear. As one type of motion sensor, an acceleration sensor can detect magnitude of accelerations in various directions (generally on three axes), may detect magnitude and a direction of the gravity when being static, and may be applied to application that recognizes the attitude of the mobile phone (for example, switching between landscape orientation and portrait orientation, a related game, and magnetometer attitude calibration), a function related to vibration recognition (for example, a pedometer and a knock), and the like. Other sensors, such as a gyroscope, a barometer, a hygrometer, a thermometer, and an infrared sensor, which may be configured in the mobile phone, are not further described herein.

The audio circuit 760, a speaker 761, and a microphone 762 may provide audio interfaces between the user and the mobile phone. The audio circuit 760 may convert received audio data into an electrical signal and transmit the electrical signal to the speaker 761. The speaker 761 converts the electrical signal into a sound signal for output. In another aspect, the microphone 762 converts a collected sound signal into an electrical signal. The audio circuit 760 receives the electrical signal and converts the electrical signal into audio data, and outputs the audio data to the processor 780 for processing. Then, the processor 780 transmits the audio data to, for example, another mobile phone through the RF circuit 710, or outputs the audio data to the memory 720 for further processing.

WiFi is a short-distance wireless transmission technology. The mobile phone may help, by using the WiFi module 770, the user to transmit an email, browse a web page, access stream media, and the like, to allow wireless broadband Internet access of the user. Although FIG. 10 shows the WiFi module 770, the WiFi module 770 is not a necessary component of the mobile phone, and the WiFi module 770 may be omitted as required provided that the scope of the essence of the present invention is not changed.

The processor 780 is a control center of the mobile phone, connected to various parts of the entire mobile phone by using various interfaces and lines. By running or executing the software program and/or the module stored in the memory 720, and invoking data stored in the memory 720, the processor executes various functions of the mobile phone and performs data processing, thereby detecting the entire mobile phone. In some embodiments, the processor 780 may include one or more processing units. Preferably, the processor 780 may integrate an application processor and a modem processor. The application processor mainly processes an operating system, a user interface, an application, and the like. The modem processor mainly processes wireless communication. The foregoing modem processor may not be integrated into the processor 780.

The mobile phone further includes the power supply 790 (for example, a battery) for supplying power to the components. Preferably, the power supply may be logically connected to the processor 780 by using a power management system, thereby implementing functions such as charging, discharging, and power consumption management by using the power management system.

Although not shown in the figure, the mobile phone may further include a camera, a Bluetooth module, and the like. Details are not described herein again.

In this embodiment, the processor 780 included in the terminal device is further configured to perform any one of the image rendering methods provided in the embodiments of this application.

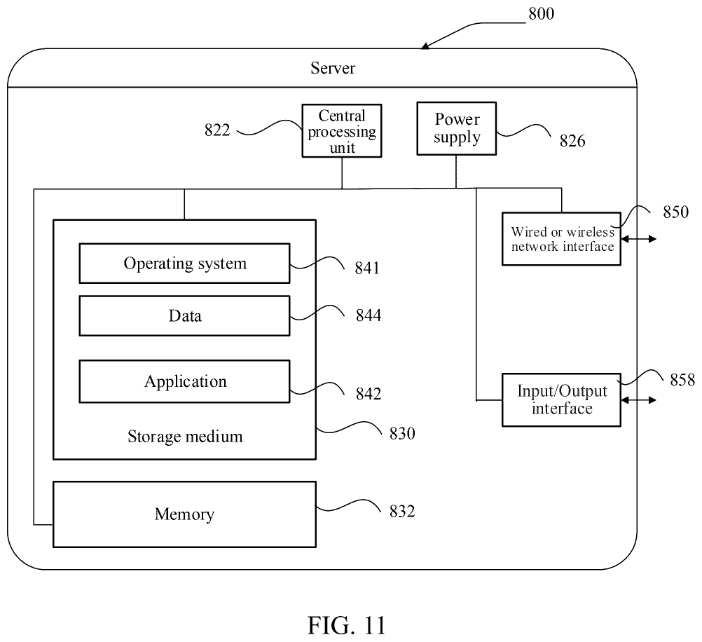

An embodiment of this application further provides a server. FIG. 11 is a structural diagram of a server 800 according to an embodiment of this application. The server 800 greatly differs due to different configurations or performance. The server may include one or more central processing units (CPUs) 822 (for example, one or more processors), a memory 832, and one or more storage media 830 (for example, one or more mass storage devices) for storing applications 842 or data 844. The memory 832 and the storage medium 830 may be transient or persistent storages. The program stored in the storage medium 830 may include one or more modules (not shown in the figure), where each module may include a series of instruction operations to the server. Further, the CPU 822 may be configured to communicate with the storage medium 830, and perform, on the server 800, the series of instruction operations in the storage medium 830.

The server 800 may further include one or more power supplies 826, one or more wired or wireless network interfaces 850, one or more input/output interfaces 858, and/or one or more operating systems 841, for example, Windows Server™, Mac OS X™, Unix™, Linux™, or FreeBSD™.

Operations performed by the server in the foregoing embodiments may be based on the server structure shown in FIG. 11.

An embodiment of this application further provides a computer-readable storage medium, configured to store a computer program. The computer program is configured to perform any one of implementations in the image rendering method provided in the foregoing embodiments.

An embodiment of this application further provides a computer program product including a computer program. The computer program, when run on a computer device, causes the computer device to perform the image rendering method provided in any one of the foregoing embodiments.

In the specific implementations of this application, relevant data such as user information (for example, a lighting effect parameter or an effect adjustment operation) is involved. When the foregoing embodiments of this application are applied to a specific product or technology, a permission or consent of a user is required, and collection, use, and processing of the related data need to comply with relevant laws, regulations, and standards of relevant countries and regions.

A person of ordinary skill in the art may understand that all or some of the steps of the method embodiments may be implemented by a program instructing relevant hardware. The program may be stored in a computer-readable storage medium. When the program runs, the operations of the method embodiments are performed. The foregoing storage medium may be at least one of the following media: any medium that can store a program code, such as a read-only memory (ROM), a random access memory (RAM), a magnetic disk, or an optical disc.

The embodiments in this specification are all described in a progressive manner, for same or similar parts in the embodiments, reference may be made to these embodiments, and each embodiment focuses on a difference from other embodiments. Especially, device and system embodiments are basically similar to the method embodiments, and therefore are described briefly. For related parts, refer to partial descriptions in the method embodiments. The described device and system embodiments are merely exemplary. The units described as separate parts may or may not be physically separated, and parts displayed as units may or may not be physical units, may be located in one position, or may be distributed on a plurality of network units. Some or all of the modules may be selected according to actual needs to achieve the objectives of the solutions of this embodiment. A person of ordinary skill in the art may understand and implement the embodiments without creative efforts.

The foregoing descriptions are merely a specific implementation of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An image rendering method, performed by a computer device, comprising:
determining, according to a camera location of a virtual camera and an object location corresponding to a target object in a three-dimensional scene, whether a pixel in an imaging plane of the virtual camera overlaps with the target object;
in response to determining that the pixel overlaps with the target object, determining, according to the pixel and the object location, a positioning point corresponding to a visible point, the visible point being a point, on the target object, that overlaps with the pixel, and the positioning point being a point, on the target object, that is farthest away from the pixel on a straight line connecting the pixel and the visible point;
determining a distance between the visible point and the positioning point as a scattering distance, in the target object, corresponding to the pixel under a target rendering light source; and
determining pixel information of the pixel based on the scattering distance and the target rendering light source.

2. The method according to claim 1, wherein the visible point is determined as follows:
determining, according to the camera location and the object location, a visible surface of the target object with respect to the camera location, the visible surface being a surface of the target object acquired by the virtual camera at the camera location;
determining, according to the camera location and the object location, a first location corresponding to the pixel and a plurality of second locations corresponding to a plurality of points on the visible surface, respectively; and
determining the visible point from the plurality of points according to the first location and the plurality of second locations.

3. The method according to claim 2, wherein:
determining the first location and the plurality of second locations includes:
establishing a space coordinate system corresponding to the camera location, an origin of the space coordinate system being the camera location, a z-axis of the space coordinate system being a camera optical axis corresponding to the camera location, and a plane formed by an x-axis and a y-axis of the space coordinate system being the imaging plane; and
determining, according to the space coordinate system and the object location, a coordinate location of the pixel in the space coordinate system as the first location, and determining coordinate locations of the plurality of points on the visible surface in the space coordinate system as the plurality of second locations; and
determining the visible point from the plurality of points includes:
determining, from the plurality of points, a point with same x-axis coordinate and y-axis coordinate as the pixel, and with a corresponding z-axis coordinate closest to a z-axis coordinate of the pixel, as the visible point.

4. The method according to claim 1, wherein determining the positioning point includes:
determining, according to the pixel and the object location, a plurality of candidate points included in the target object and located on the straight line; and
determining one of the plurality of candidate points that is farthest away from the pixel as the positioning point.

5. The method according to claim 4,
wherein the target object is one of a plurality of objects in the three-dimensional scene;
the method further comprising:
determining, according to the object location corresponding to the target object, a plurality of object points of the target object; and
adding an object identifier corresponding to the target object to the plurality of object points;
wherein determining the plurality of candidate points includes:
determining, according to the pixel and object locations respectively corresponding to the plurality of objects, a plurality of initial candidate points included in the plurality of objects and located on the straight line; and
determining ones of the plurality of initial candidate points having the object identifier as the plurality of to-be-determined points.

6. The method according to claim 1, wherein determining the pixel information includes:
determining a light source parameter corresponding to the target rendering light source, the light source parameter identifying a lighting manner of the target rendering light source for the target object; and
determining the pixel information according to the scattering distance and the light source parameter.

7. The method according to claim 6, wherein the light source parameter includes at least one of:
a light source location parameter identifying a light source location corresponding to the target rendering light source, or
a light source direction parameter identifying a light source direction of the target rendering light source.

8. The method according to claim 6, further comprising:
obtaining a lighting effect parameter corresponding to the pixel, the lighting effect parameter being configured for adjusting a lighting effect of the target rendering light source on the pixel;
wherein determining the pixel information according to the scattering distance and the light source parameter includes:
determining the pixel information according to the scattering distance, the light source parameter, and the lighting effect parameter.

9. The method according to claim 8, wherein the lighting effect parameter includes at least one of:
an offset parameter configured for adjusting a light source direction of the target rendering light source,
an aggregation degree parameter configured for adjusting an aggregation degree between a plurality of lighting effects presented through the pixel, or
a change parameter configured for adjusting a change degree of a lighting effect changing as a shining distance changes, the shining distance being a distance between the target rendering light source and the target object.

10. The method according to claim 1,
wherein the target object is a translucent object;
the method further comprising, before determining whether the pixel overlaps with the target object:
determining an opaque object in the three-dimensional scene;
determining, according to an object location corresponding to the opaque object and the camera location, a target opaque object, in the imaging plane, that corresponds to the opaque object; and
rendering the target opaque object according to the camera location and an object location corresponding to the target opaque object.

11. The method according to claim 1, further comprising:
obtaining an effect adjustment operation for adjusting a presentation effect of the target object in the imaging plane; and
adjusting the pixel information according to the effect adjustment operation, to obtain a target image.

12. A computer device comprising:
a memory storing a computer program; and
a processor configured to execute instructions in the computer program to:
determine, according to a camera location of a virtual camera and an object location corresponding to a target object in a three-dimensional scene, whether a pixel in an imaging plane of the virtual camera overlaps with the target object;
in response to determining that the pixel overlaps with the target object, determine, according to the pixel and the object location, a positioning point corresponding to a visible point, the visible point being a point, on the target object, that overlaps with the pixel, and the positioning point being a point, on the target object, that is farthest away from the pixel on a straight line connecting the pixel and the visible point;
determine a distance between the visible point and the positioning point as a scattering distance, in the target object, corresponding to the pixel under a target rendering light source; and
determine pixel information of the pixel based on the scattering distance and the target rendering light source.

13. The computer device according to claim 12, wherein the visible point is determined as follows:
determining, according to the camera location and the object location, a visible surface of the target object with respect to the camera location, the visible surface being a surface of the target object acquired by the virtual camera at the camera location;
determining, according to the camera location and the object location, a first location corresponding to the pixel and a plurality of second locations corresponding to a plurality of points on the visible surface, respectively; and
determining the visible point from the plurality of points according to the first location and the plurality of second locations.

14. The computer device according to claim 13, wherein the processor is further configured to execute instructions to:
when determining the first location and the plurality of second locations:
establish a space coordinate system corresponding to the camera location, an origin of the space coordinate system being the camera location, a z-axis of the space coordinate system being a camera optical axis corresponding to the camera location, and a plane formed by an x-axis and a y-axis of the space coordinate system being the imaging plane; and
determine, according to the space coordinate system and the object location, a coordinate location of the pixel in the space coordinate system as the first location, and determining coordinate locations of the plurality of points on the visible surface in the space coordinate system as the plurality of second locations; and
when determining the visible point from the plurality of points:
determine, from the plurality of points, a point with same x-axis coordinate and y-axis coordinate as the pixel, and with a corresponding z-axis coordinate closest to a z-axis coordinate of the pixel, as the visible point.

15. The computer device according to claim 12, wherein the processor is further configured to execute instructions to, when determining the positioning point:
determine, according to the pixel and the object location, a plurality of candidate points included in the target object and located on the straight line; and
determine one of the plurality of candidate points that is farthest away from the pixel as the positioning point.

16. The computer device according to claim 15, wherein:
the target object is one of a plurality of objects in the three-dimensional scene; and
the processor is further configured to execute instructions to:
determine, according to the object location corresponding to the target object, a plurality of object points of the target object;
add an object identifier corresponding to the target object to the plurality of object points; and
when determining the plurality of candidate points:
determine, according to the pixel and object locations respectively corresponding to the plurality of objects, a plurality of initial candidate points included in the plurality of objects and located on the straight line; and
determine ones of the plurality of initial candidate points having the object identifier as the plurality of to-be-determined points.

17. The computer device according to claim 12, wherein the processor is further configured to execute instructions to, when determining the pixel information:
determine a light source parameter corresponding to the target rendering light source, the light source parameter identifying a lighting manner of the target rendering light source for the target object; and
determine the pixel information according to the scattering distance and the light source parameter.

18. The computer device according to claim 17, wherein the light source parameter includes at least one of:
a light source location parameter identifying a light source location corresponding to the target rendering light source, or
a light source direction parameter identifying a light source direction of the target rendering light source.

19. The computer device according to claim 17, wherein the processor is further configured to execute instructions to:
obtain a lighting effect parameter corresponding to the pixel, the lighting effect parameter being configured for adjusting a lighting effect of the target rendering light source on the pixel; and
when determining the pixel information according to the scattering distance and the light source parameter:
determine the pixel information according to the scattering distance, the light source parameter, and the lighting effect parameter.

20. A non-transitory computer-readable storage medium storing a computer program that, when executed by a processor, causes a computer device including the processor to:
determine, according to a camera location of a virtual camera and an object location corresponding to a target object in a three-dimensional scene, whether a pixel in an imaging plane of the virtual camera overlaps with the target object;
in response to determining that the pixel overlaps with the target object, determine, according to the pixel and the object location, a positioning point corresponding to a visible point, the visible point being a point, on the target object, that overlaps with the pixel, and the positioning point being a point, on the target object, that is farthest away from the pixel on a straight line connecting the pixel and the visible point;
determine a distance between the visible point and the positioning point as a scattering distance, in the target object, corresponding to the pixel under a target rendering light source; and
determine pixel information of the pixel based on the scattering distance and the target rendering light source.
